(19) United States
(12) Patent Application Publication
(10) Pub. No.: US 2026/0135686 A1
(43) Pub. Date: May 14, 2026

(54) FULL-DUPLEX TRANSMISSION AND RECEPTION CIRCUIT, SERIALIZER, DESERIALIZER, AND VEHICLE

(71) Applicant: AI Micron Ltd., Shanghai (CN)

(72) Inventors: Yong Shen, Shanghai (CN); Xin Liu, Saratoga, CA (US); Wenbo Wang, Beijing (CN); Huayang Zeng, Shanghai (CN)

(21) Appl. No.: 18/948,090

(22) Filed: Nov. 14, 2024

(30) Foreign Application Priority Data
Oct. 8, 2023 (CN) 202311289213.6

(51) Int. Cl. H04L 5/14

(52) U.S. Cl. CPC H04L 5/1469; H04L 5/1461

(57) ABSTRACT

A full-duplex transmission and reception circuit includes a transmission module, a transmission channel, and a receiving module connected in sequence. The transmission module includes a forward signal driving module and a reverse signal receiving module. The receiving module includes a forward signal receiving module and a reverse signal driving module. The forward signal driving module is configured to transmit a forward signal through the transmission channel to the forward signal receiving module, and the reverse signal driving module is configured to transmit a reverse signal through the transmission channel to the reverse signal receiving module. The reverse signal is a common-mode signal. By utilizing the full-duplex transmission and reception circuit disclosed herein, full-duplex communication can be achieved on a single channel, significantly reducing costs, while the common-mode signal can minimize adverse effects on the forward high-speed signal, facilitating long-distance transmission.

### CROSS-REFERENCE TO RELATED APPLICATIONS

This application claims priority to Chinese Patent Application No. 202311289213.6, filed with the China National Intellectual Property Administration on Oct. 8, 2023, and entitled “Full-Duplex Transmission and Reception Circuit, Serializer, Deserializer, and Vehicle,” which is incorporated herein by reference in its entirety.

### TECHNICAL FIELD

This disclosure relates to the field of electronic and electrical technologies, specifically concerning a full-duplex transmission and reception circuit, serializer, deserializer, and vehicle.

### BACKGROUND

A Serializer-Deserializer (SERDES) system is a communication technology in which multiple low-speed parallel signals at the transmitting end are converted into high-speed serial signals. After transmission through media such as optical fibers or coaxial cables, the high-speed serial signals are converted back into low-speed parallel signals at the receiving end.

Currently, in related technologies, the connection between the serializer circuit and deserializer circuit is generally a unidirectional channel without a return path, as seen in HDMI (High Definition Multimedia Interface) and LVDS (Low Voltage Differential Signaling). Although some protocols, such as DP (DisplayPort), achieve return transmission of control information by adding additional channels, this approach increases costs, limiting its widespread application and posing certain limitations.

### SUMMARY

Based on this, it is necessary to address the above-mentioned defects or shortcomings by providing a full-duplex transmission and reception circuit, serializer, deserializer, and vehicle that can achieve full-duplex communication over a single channel while reducing costs.

In a first aspect, embodiments of the present disclosure provide a full-duplex transmission and reception circuit, which includes a transmission module, a transmission channel, and a receiving module that are connected in sequence.

The transmission module includes a forward signal driving module and a reverse signal receiving module, with a first terminal of the forward signal driving module connected to a first terminal of the reverse signal receiving module and a first terminal of the transmission channel, and a second terminal of the forward signal driving module is connected to a second terminal of the reverse signal receiving module and a second terminal of the transmission channel. A third terminal of the transmission channel is grounded.

The receiving module includes a forward signal receiving module and a reverse signal driving module, with a first terminal of the forward signal receiving module connected to a fourth terminal of the transmission channel and a first terminal of the reverse signal driving module, and a second terminal of the forward signal receiving module is connected to a second terminal of the reverse signal driving module and a fifth terminal of the transmission channel. A sixth terminal of the transmission channel is grounded.

The forward signal driving module is configured to transmit a forward signal through the transmission channel to the forward signal receiving module, while the reverse signal driving module is configured to transmit a reverse signal through the transmission channel to the reverse signal receiving module. The reverse signal is a common-mode signal.

Optionally, in some embodiments of the present disclosure, the reverse signal driving module includes a reverse signal driving unit and a switching unit.

An output terminal of the reverse signal driving unit is connected to a first terminal and a second terminal of the switching unit, while a third terminal of the switching unit is connected to a second terminal of the forward signal receiving module, and a fourth terminal of the switching unit is connected to a first terminal of the forward signal receiving module.

The reverse signal driving unit is configured to transmit the reverse signal to the switching unit, and the switching unit is configured to switch a path for transmitting the reverse signal to the reverse signal receiving module.

Optionally, in some embodiments of the present disclosure, the switching unit includes a first switch, a first current source, a first resistor, a second switch, a second current source, and a second resistor;

A first terminal of the first switch and a first terminal of the second switch are both connected to the output terminal of the reverse signal driving unit, a second terminal of the first switch is connected to a first terminal of a first current source, while a second terminal of the first current source is grounded. A third terminal of the first switch is connected to a second terminal of the forward signal receiving module and a first terminal of the first resistor, with a second terminal of the first resistor connected to a power supply and a first terminal of the second resistor, and a second terminal of the second resistor connected to a second terminal of the second switch and a first terminal of the forward signal receiving module, while a third terminal of the second switch is connected to a first terminal of the second current source, with a second terminal of the second current source grounded.

Optionally, in some embodiments of the present disclosure, the reverse signal receiving module includes a reverse signal receiving unit and an amplification unit.

A first terminal of the reverse signal receiving unit is connected to a first terminal of the forward signal driving module and a first terminal of the transmission channel. A second terminal of the reverse signal receiving unit is connected to a second terminal of the forward signal driving module and a second terminal of the transmission channel, while a third terminal of the reverse signal receiving unit is connected to an input terminal of the amplification unit.

The reverse signal receiving unit is configured to receive the reverse signal, and the amplification unit is configured to amplify the reverse signal.

Optionally, in some embodiments of the present disclosure, the reverse signal receiving unit includes a third resistor, a fourth resistor, a fifth resistor, and a sixth resistor.

A first terminal of the third resistor is connected to a first terminal of the forward signal driving module and a first terminal of the transmission channel, and a second terminal of the third resistor is connected to a power supply and a first terminal of the fourth resistor, a second terminal of the fourth resistor is connected to a second terminal of the forward signal driving module, a second terminal of the transmission channel, and a first terminal of the fifth resistor, with a second terminal of the fifth resistor connected to a first terminal of the sixth resistor and an input terminal of the amplification unit, while a second terminal of the sixth resistor is connected to the second terminal of the third resistor.

Optionally, in some embodiments of the present disclosure, the transmission channel includes a first capacitor, a second capacitor, a third capacitor, a fourth capacitor, a seventh resistor, and an eighth resistor.

A first terminal of the first capacitor is respectively connected to a first terminal of the forward signal driving module and a first terminal of the reverse signal receiving module, and a second terminal of the first capacitor is connected to a first terminal of the second capacitor. A second terminal of the second capacitor is connected to a first terminal of the forward signal receiving module and a first terminal of the reverse signal driving module. A first terminal of the third capacitor is connected to a second terminal of the forward signal driving module and a second terminal of the reverse signal receiving module, while a second terminal of the third capacitor is connected to a first terminal of the seventh resistor, with a second terminal of the seventh resistor grounded. A first terminal of the fourth capacitor is connected to a second terminal of the forward signal receiving module and a second terminal of the reverse signal driving module, and a second terminal of the fourth capacitor is connected to a first terminal of the eighth resistor, with a second terminal of the eighth resistor grounded.

Optionally, in some embodiments of the present disclosure, a coaxial cable is connected between the first capacitor and the second capacitor.

In a second aspect, embodiments of the present disclosure provide a serializer, which includes a transmission module as described in any of the first aspect.

In a third aspect, embodiments of the present disclosure provide a deserializer, which includes a receiving module as described in any of the first aspect.

In a fourth aspect, embodiments of the present disclosure provide a vehicle that includes a full-duplex transmission and reception circuit as described in any of the first aspect.

From the above technical solutions, it can be seen that embodiments of the present disclosure have the following advantages.

This disclosure provides a full-duplex transmission and reception circuit, serializer, deserializer, and vehicle. The full-duplex transmission and reception circuit utilizes the reverse signal driving module of the receiving module to transmit the reverse signal through the transmission channel to the reverse signal receiving module of the transmission module, thereby allowing the forward signal and the reverse signal to share a single transmission channel. This enables full-duplex communication over a single channel, significantly reducing costs. Additionally, the common-mode signal can minimize the adverse effects on the forward high-speed signal, facilitating long-distance transmission.

### BRIEF DESCRIPTION OF THE DRAWINGS

Other features, objectives, and advantages of the present invention will become more apparent from the following detailed description of non-limiting embodiments with reference to the accompanying drawings:

FIG. 1 is a block diagram of a full-duplex transmission and reception circuit provided by embodiments of the present disclosure;

FIG. 2 is a specific example of a full-duplex transmission and reception circuit provided by embodiments of the present disclosure;

FIG. 3 is a block diagram of a serializer provided by embodiments of the present disclosure;

FIG. 4 is a block diagram of a deserializer provided by embodiments of the present disclosure;

FIG. 5 is a block diagram of a vehicle provided by embodiments of the present disclosure.

### Reference Numerals

10—Full—duplex transmission and reception circuit; 101—Transmission module; 1011 Forward signal driving module; 1012—Reverse signal receiving module; 102—Transmission channel; 103—Receiving module; 1031—Forward signal receiving module; 1032—Reverse signal driving module; 20—Serializer; 30—Deserializer; 40—Vehicle.

### DETAIL DESCRIPTION OF THE EMBODIMENTS

To enable those skilled in the art to better understand the solutions of the present invention, the technical solutions in the embodiments of the present invention will be clearly and thoroughly described below in conjunction with the accompanying drawings. It is evident that the described embodiments represent only a portion of the embodiments of the present invention, not all of them. All other embodiments obtained by those of ordinary skill in the art without inventive effort, based on the embodiments of the present invention, shall fall within the scope of protection of the present disclosure.

The terms “first,” “second,” “third,” “fourth,” etc., as used in the specification, claims, and the above drawings (if present), are intended to distinguish similar objects and are not necessarily used to indicate a specific sequence or order. It should be understood that such terms may be used interchangeably, where appropriate, so that the embodiments of the present invention can be implemented in sequences other than those illustrated or described herein.

Furthermore, the terms “comprise,” “include,” “have,” and any variations thereof are intended to cover non-exclusive inclusion. For example, a process, method, system, product, or device that comprises a series of steps or modules is not limited to the explicitly listed steps or modules but may include other steps or modules not explicitly listed or inherent to such process, method, product, or device.

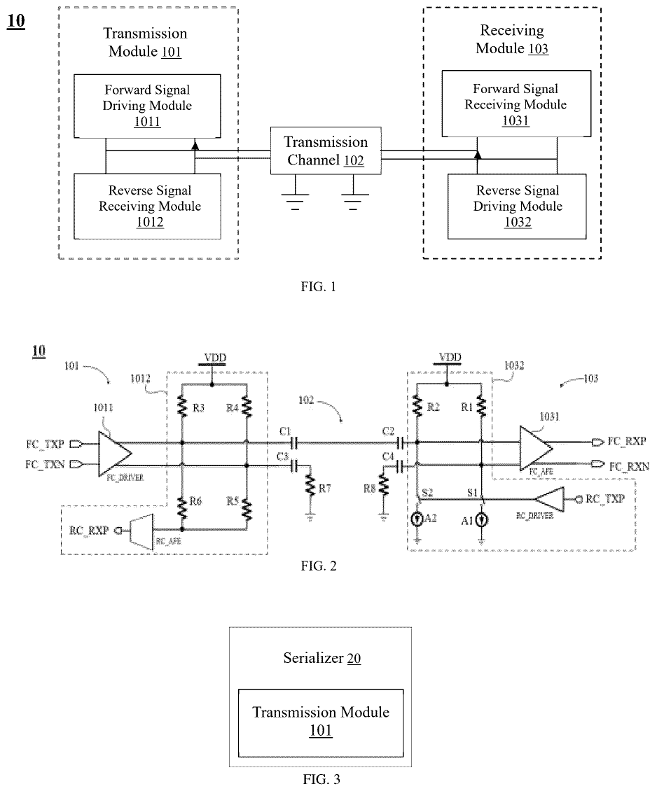

To facilitate a better understanding of the present invention, the following provides a detailed description of the full-duplex transmission and reception circuit, serializer, deserializer, and vehicle offered in the embodiments of the present invention, with reference to FIGS. 1 to 5.

Please refer to FIG. 1, which is a structural block diagram of a full-duplex transmission and reception circuit provided by the embodiments of the present disclosure. The full-duplex transmission and reception circuit 10 includes a transmission module 101, a transmission channel 102, and a receiving module 103, which are connected in sequence.

The transmission module 101 may include a forward signal driving module 1011 and a reverse signal receiving module 1012. The first terminal of the forward signal driving module 1011 is respectively connected to the first terminal of the reverse signal receiving module 1012 and the first terminal of the transmission channel 102. The second terminal of the forward signal driving module 1011 is respectively connected to the second terminal of the reverse signal receiving module 1012 and the second terminal of the transmission channel 102, while the third terminal of the transmission channel 102 is grounded.

The receiving module 103 may include a forward signal receiving module 1031 and a reverse signal driving module 1032. The first terminal of the forward signal receiving module 1031 is respectively connected to the fourth terminal of the transmission channel 102 and the first terminal of the reverse signal driving module 1032. The second terminal of the forward signal receiving module 1031 is respectively connected to the second terminal of the reverse signal driving module 1032 and the fifth terminal of the transmission channel 102, while the sixth terminal of the transmission channel 102 is grounded.

In practical use, the forward signal driving module 1011 of the present disclosure can transmit a forward signal to the forward signal receiving module 1031 through the transmission channel 102, while the reverse signal driving module 1032 can transmit a reverse signal to the reverse signal receiving module 1012 through the transmission channel 102. The reverse signal is a common-mode signal.

For example, as shown in FIG. 2, the specific circuit structures of the various components in the full-duplex transmission and reception circuit 10 will be described in detail. Here, FC denotes the forward channel, RC denotes the reverse channel, TX denotes transmission, and RX denotes reception.

In the embodiments of the present invention, the reverse signal driving module 1032 may include a reverse signal driving unit and a switching unit. The output of the reverse signal driving unit is connected to the first and second terminals of the switching unit. The third terminal of the switching unit (configured to connect to the second terminal of the forward signal receiving module 1031) is connected to the second terminal of the forward signal receiving module 1031, while the fourth terminal (configured to connect to the first terminal of the reverse signal driving module 1032) is connected to the first terminal of the forward signal receiving module 1031. In practical use, the reverse signal driving unit can transmit the reverse signal to the switching unit, which is capable of switching the path for transmitting the reverse signal to the reverse signal receiving module 1012.

Furthermore, the switching unit in this disclosure includes, but is not limited to, a first switch S1, a first current source A1, a first resistor R1, a second switch S2, a second current source A2, and a second resistor R2. The first terminal of the first switch S1 and the first terminal of the second switch S2 are both connected to the output of the reverse signal driving unit. The second terminal of the first switch S1 is connected to the first terminal of the first current source A1, while the second terminal of the first current source A1 is grounded. The third terminal of the first switch S1 is respectively connected to the second terminal of the forward signal receiving module 1031 and the first terminal of the first resistor R1. The second terminal of the first resistor R1 is connected to both the power supply (VDD) and the first terminal of the second resistor R2. The second terminal of the second resistor R2 is connected to the second terminal of the second switch S2 and the first terminal of the forward signal receiving module 1031. The third terminal of the second switch S2 is connected to the first terminal of the second current source A2, while the second terminal of the second current source A2 is grounded.

Additionally, the reverse signal receiving module 1012 in this disclosure may include a reverse signal receiving unit and an amplification unit. The first terminal of the reverse signal receiving unit (corresponding to the first terminal of the reverse signal receiving module 1012) is connected to the first terminal of the forward signal driving module 1011 and the first terminal of the transmission channel 102. The second terminal of the reverse signal receiving unit (corresponding to the second terminal of the reverse signal receiving module 1012) is connected to the second terminal of the forward signal driving module 1011 and the second terminal of the transmission channel 102. The third terminal of the reverse signal receiving unit is connected to the input of the amplification unit. In practical use, the reverse signal receiving unit can receive the reverse signal, while the amplification unit can amplify the reverse signal. This amplification unit may include an Analog Front End (AFE) circuit.

Furthermore, the reverse signal receiving unit in this disclosure includes, but is not limited to, a third resistor R3, a fourth resistor R4, a fifth resistor R5, and a sixth resistor R6. The first terminal of the third resistor R3 is connected to the first terminal of the forward signal driving module 1011 and the first terminal of the transmission channel 102. The second terminal of the third resistor R3 is connected to both the power supply (VDD) and the first terminal of the fourth resistor R4. The second terminal of the fourth resistor R4 is connected to the second terminal of the forward signal driving module 1011, the second terminal of the transmission channel 102, and the first terminal of the fifth resistor R5. The second terminal of the fifth resistor R5 is connected to both the first terminal of the sixth resistor R6 and the input of the amplification unit, while the second terminal of the sixth resistor R6 is connected to the second terminal of the third resistor R3.

Additionally, the transmission channel in this disclosure may include a first capacitor C1, a second capacitor C2, a third capacitor C3, a fourth capacitor C4, a seventh resistor R7, and an eighth resistor R8. The first terminal of the first capacitor C1 (corresponding to the first terminal of the transmission channel 102) is connected to both the first terminal of the forward signal driving module 1011 and the first terminal of the reverse signal receiving module 1012. The second terminal of the first capacitor C1 is connected to the first terminal of the second capacitor C2. The second terminal of the second capacitor C2 (corresponding to the fourth terminal of the transmission channel 102) is connected to both the first terminal of the forward signal receiving module 1031 and the first terminal of the reverse signal driving module 1032. The first terminal of the third capacitor C3 (corresponding to the second terminal of the transmission channel 102) is connected to both the second terminal of the forward signal driving module 1011 and the second terminal of the reverse signal receiving module 1012, while the second terminal of the third capacitor C3 is connected to the first terminal of the seventh resistor R7, which has its second terminal grounded. The first terminal of the fourth capacitor C4 (corresponding to the fifth terminal of the transmission channel 102) is connected to both the second terminal of the forward signal receiving module 1031 and the second terminal of the reverse signal driving module 1032. The second terminal of the fourth capacitor C4 is connected to the first terminal of the eighth resistor R8, and the second terminal of the eighth resistor R8 is grounded.

Furthermore, in this disclosure, a coaxial cable (COAX) is connected between the first capacitor C1 and the second capacitor C2.

The following describes the working process of the full-duplex transmission and reception circuit 10 provided in this disclosure, in conjunction with FIG. 2. Firstly, the FC_TXP and FC_TXN signals at the transmission module 101 pass through the forward signal driving module 1011 and transmission channel 102, and are transmitted to the reception module 103. Next, the forward signal receiving module 1031 at the reception module 103 receives this forward signal, while the reverse signal driving module 1032 transmits the reverse low-speed common-mode signal back through the transmission channel 102 to the transmission module 101. Due to the use of COAX transmission mode, a low-speed common-mode signal is observed only on the third resistor R3, while it is not visible on the fourth resistor R4. Furthermore, the low-speed common-mode signal observed on the third resistor R3 can be received and transmitted to the amplification unit via the fifth resistor R5 and the sixth resistor R6, ultimately achieving full-duplex communication over a single channel.

As another aspect, this disclosure provides a serializer. As shown in FIG. 3, the serializer 20 includes, but is not limited to, the transmission module 101 corresponding to the embodiments in FIGS. 1 and 2.

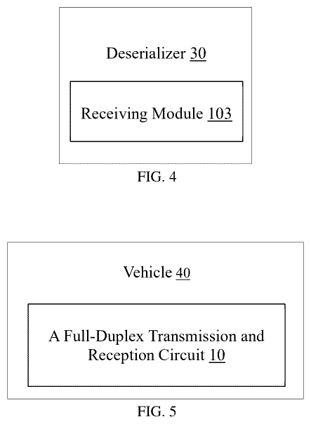

As yet another aspect, this disclosure provides a deserializer. As shown in FIG. 4, the deserializer 30 includes, but is not limited to, the receiving module 103 corresponding to the embodiments in FIGS. 1 and 2.

As yet another aspect, this disclosure provides a vehicle. As shown in FIG. 5, the vehicle 40 may include the full-duplex transmission and reception circuit 10 corresponding to the embodiments in FIGS. 1 and 2.

The full-duplex transmission and reception circuit, serializer, deserializer, and vehicle provided by this disclosure utilize the reverse signal driving module of the receiving module to transmit the reverse signal through the transmission channel to the reverse signal receiving module of the transmission module, thereby sharing a transmission channel with the forward signal. This enables full-duplex communication over a single channel, significantly reducing costs, while the common-mode signal mitigates adverse effects on the forward high-speed signal, facilitating long-distance transmission.

The technical features of the above embodiments can be combined in any way. For the sake of brevity, not all possible combinations of the technical features in the described embodiments are explicitly detailed. However, as long as there are no conflicts among the combinations of these technical features, they should be considered within the scope disclosed in this specification.

The above embodiments represent only a few implementations of the present invention. Although the descriptions are relatively specific and detailed, they should not be construed as limiting the scope of the invention. It should be noted that those skilled in the art may make various modifications and improvements without departing from the spirit of the invention, and all such variations fall within the scope of protection of the present invention.

What is claimed is:

1. A full-duplex transmission and reception circuit, comprising:
a transmission module, a transmission channel, and a receiving module connected in sequence,
wherein the transmission module includes a forward signal driving module and a reverse signal receiving module, with a first terminal of the forward signal driving module connected to a first terminal of the reverse signal receiving module and a first terminal of the transmission channel, and a second terminal of the forward signal driving module connected to a second terminal of the reverse signal receiving module and a second terminal of the transmission channel, wherein a third terminal of the transmission channel is grounded;
wherein the receiving module includes a forward signal receiving module and a reverse signal driving module, with a first terminal of the forward signal receiving module connected to a fourth terminal of the transmission channel and a first terminal of the reverse signal driving module, and a second terminal of the forward signal receiving module connected to a second terminal of the reverse signal driving module and a fifth terminal of the transmission channel, wherein a sixth terminal of the transmission channel is grounded;
wherein the forward signal driving module is configured to transmit a forward signal through the transmission channel to the forward signal receiving module, and the reverse signal driving module is configured to transmit a reverse signal through the transmission channel to the reverse signal receiving module, wherein the reverse signal is a common-mode signal;
wherein the reverse signal driving module comprises a reverse signal driving unit and a switching unit;
wherein an output of the reverse signal driving unit is connected to a first terminal and a second terminal of the switching unit, a third terminal of the switching unit is connected to a second terminal of the forward signal receiving module, and a fourth terminal of the switching unit is connected to a first terminal of the forward signal receiving module;
wherein the reverse signal driving unit is configured to transmit the reverse signal to the switching unit, and the switching unit is configured to switch a path for transmitting the reverse signal to the reverse signal receiving module.

2. The full-duplex transmission and reception circuit of claim 1, wherein the switching unit comprises a first switch, a first current source, a first resistor, a second switch, a second current source, and a second resistor;
wherein a first terminal of the first switch and a first terminal of the second switch are both connected to the output terminal of the reverse signal driving unit, a second terminal of the first switch is connected to a first terminal of the first current source, and a second terminal of the first current source is grounded; wherein a third terminal of the first switch is connected to a second terminal of the forward signal receiving module and a first terminal of the first resistor, with a second terminal of the first resistor connected to a power supply and a first terminal of the second resistor, and a second terminal of the second resistor connected to a second terminal of the second switch and a first terminal of the forward signal receiving module; wherein a third terminal of the second switch is connected to a first terminal of the second current source, with a second terminal of the second current source grounded.

3. The full-duplex transmission and reception circuit of claim 1, wherein the reverse signal receiving module comprises a reverse signal receiving unit and an amplification unit;
wherein a first terminal of the reverse signal receiving unit is connected to a first terminal of the forward signal driving module and a first terminal of the transmission channel, and a second terminal of the reverse signal receiving unit is connected to a second terminal of the forward signal driving module and a second terminal of the transmission channel, and a third terminal of the reverse signal receiving unit is connected to an input terminal of the amplification unit;
and wherein the reverse signal receiving unit is configured to receive the reverse signal, and the amplification unit is configured to amplify the reverse signal.

4. The full-duplex transmission and reception circuit of claim 3, wherein the reverse signal receiving unit comprises a third resistor, a fourth resistor, a fifth resistor, and a sixth resistor;
wherein a first terminal of the third resistor is connected to a first terminal of the forward signal driving module and a first terminal of the transmission channel, and a second terminal of the third resistor is connected to a power supply and a first terminal of the fourth resistor; wherein a second terminal of the fourth resistor is connected to a second terminal of the forward signal driving module, a second terminal of the transmission channel, and a first terminal of the fifth resistor, with a second terminal of the fifth resistor connected to a first terminal of the sixth resistor and an input terminal of the amplification unit, and a second terminal of the sixth resistor is connected to the second terminal of the third resistor.

5. The full-duplex transmission and reception circuit of claim 1, wherein the transmission channel comprises a first capacitor, a second capacitor, a third capacitor, a fourth capacitor, a seventh resistor, and an eighth resistor;
wherein a first terminal of the first capacitor is connected to a first terminal of the forward signal driving module and a first terminal of the reverse signal receiving module, and a second terminal of the first capacitor is connected to a first terminal of the second capacitor; wherein a second terminal of the second capacitor is connected to a first terminal of the forward signal receiving module and a first terminal of the reverse signal driving module; wherein a first terminal of the third capacitor is connected to a second terminal of the forward signal driving module and a second terminal of the reverse signal receiving module, and a second terminal of the third capacitor is connected to a first terminal of the seventh resistor, with a second terminal of the seventh resistor grounded; wherein a first terminal of the fourth capacitor is connected to a second terminal of the forward signal receiving module and a second terminal of the reverse signal driving module, and a second terminal of the fourth capacitor is connected to a first terminal of the eighth resistor, with a second terminal of the eighth resistor grounded.

6. The full-duplex transmission and reception circuit according to claim 5, further comprising a coaxial cable connected between the first capacitor and the second capacitor.

7. A vehicle, comprising the full-duplex transmission and reception circuit of claim 1.

8. A full-duplex transmission and reception circuit comprises a transmission module, a transmission channel, and a receiving module connected in sequence, wherein the transmission module includes a forward signal driving module and a reverse signal receiving module, the receiving module includes a forward signal receiving module and a reverse signal driving module, the forward signal driving module is configured to transmit a forward signal through the transmission channel to the forward signal receiving module, and the reverse signal driving module is configured to transmit a reverse signal through the transmission channel to the reverse signal receiving module, and the reverse signal is a common-mode signal.

9. A full-duplex transmission and reception circuit comprises:
a serializer, comprising a transmission module which includes a forward signal driving module and a reverse signal receiving module, with a first terminal of the forward signal driving module connected to a first terminal of the reverse signal receiving module and a first terminal of a transmission channel, and a second terminal of the forward signal driving module connected to a second terminal of the reverse signal receiving module and a second terminal of the transmission channel; and
a deserializer, comprising a receiving module which includes a forward signal receiving module and a reverse signal driving module, with a first terminal of the forward signal receiving module connected to a fourth terminal of the transmission channel and a first terminal of the reverse signal driving module, and a second terminal of the forward signal receiving module connected to a second terminal of the reverse signal driving module and a fifth terminal of the transmission channel.
